(19) United States
(12) Patent Application Publication
(10) Pub. No.: US 2009/0004946 A1
(43) Pub. Date: Jan. 1, 2009

(54) Interlocking toy

(75) Inventors: John Jay Sinisi, Warminster, PA (US); Emily Matt, Warminster, PA (US); Joel Carpenter, Warminster, PA (US); Jon Hughes, Warminster, PA (US); Aaron Weinstock, San Rafael, CA (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: ZinkoTek, San Rafael, CA (US)

(21) Appl. No.: 12/157,710

(22) Filed: Jun. 11, 2008

Related U.S. Application Data
(60) Provisional application No. 60/933,981, filed on Jun. 11, 2007.

(51) Int. Cl. A63H 33/08; B25B 13/00

(52) U.S. Cl. 446/124; 81/186

(57) ABSTRACT

An interlocking toy formed from construction units, where certain of the construction units include assembly members, preferably in a matrix, that are capable of interlocking with assembly members, preferably in a matching matrix, from certain other construction units. The assembly members may be in the form of notches, slots, tabs, apertures (preferably square apertures or circular apertures), oblong recesses, and tapered oblong recesses, among other similar and other geometric and non-geometric constructs. Similarly, the construction units may be formed to any geometric or non-geometric configuration. An exemplary construction unit may include assembly members in the form of notches, square apertures, and circular apertures.

### CROSS-REFERENCE

This application claims the benefit of the filing date of U.S. Provisional Patent Application No. 60/933,981 filed Jun. 11, 2007, the disclosure of which is hereby incorporated herein by reference.

### BACKGROUND OF THE INVENTION

The present invention relates to children's construction toys. More specifically, the present invention relates to children's construction toys formed from construction units, where certain of the construction units include matrices of assembly members that are capable of interlocking with matrices of assembly members from certain other construction units. Assembly members include, but are not limited to, notches, slots, tabs, apertures (particularly including square apertures and circular apertures), oblong recesses, and tapered oblong recesses.

From basic cubic building blocks to Tinkertoy® and Lego® brand building blocks, there are many construction toys available to capture the imagination and enhance the skillsets of today's children. Tinkertoy® is a registered trademark of Hasbro, Inc., Pawtucket, R.I. Lego® is a registered trademark of Interlego A.G. Corporation, Baar, Switzerland.

Cubic building blocks are often produced from wood and feature alphanumeric indicators on one or more of the six exterior surfaces. Children often build structures with the blocks and subsequently find enjoyment in knocking down the structure before repeating the process. Even where children do not intentionally knock down the resulting construction, because the blocks do not positively interconnect in any manner their usefulness as a true construction toy is limited.

Other building sets such as Tinkertoy®-type construction sets are also popular. Tinkertoy® sets typically consist of disc elements with apertures into which wooden shafts may be anchored. Although Tinkertoys have been available in the market since approximately 1913, they can be dangerous to smaller children. Moreover, the items built by Tinkertoy®-type products are often flimsy and cannot support rough handling nor the weight of the components, and thus cannot be constructed to realistically sized dimensions.

Lego®-style building blocks are also often enjoyed by children and include interlocking elements spaced at standard intervals. The interlocking elements allow the blocks to be assembled in certain configurations which can be used to form predetermined objects, such as vehicles, structures, and the like, while permitting alternate novel arrangements at the discretion of the child.

While both the predetermined and novel arrangements may elicit the child's imagination, mating options between the various components is limited, thus stifling the creativity of the child. For example, many of the components have a top surface with extending tubular members which may only be mated to the bottom surface of a corresponding second component having matching apertures. In this regard, there is no possibility for other arrangements, such as the sides of the various components to be connected to one another. This stifles the child's creativity.

Beyond limiting the creatively of children, and even in products created for small children, such as the cubic blocks or Lego® DUPLO® series of products, the products are configured from a relatively hard plastic or wood. These hard materials provide two fairly obvious limitations.

One such limitation relates to the safety of the blocks. Hard components, whether assembled or unassembled, can injure a child if the child falls on the blocks or otherwise comes in swift contact therewith, such as being the recipient of a strike from another child. When multiple children are playing with the same set of blocks, many caretakers know that it often does not take long for them to enter a dispute where one child, having particular blocks withheld from him by another child or for other reasons, throws a block in an aggressive manner toward the other child.

Another drawback is in the usefulness of blocks configured from hard plastic or wood. Such blocks do not conform and cannot be bent into various configurations. This stifles the imagination of the user and limits the effectiveness of the blocks.

Based at least on the foregoing, it has become evident that there is a need for a children's construction toy that is suitable for small children yet can support the imagination and increased skillfulness of older children, may be configured in a variety of unique and multi-optioned configurations, and may be constructed to dimensions that are sizeable to realistic dimensions, such as for example building a play house that a child may actually occupy, while also being scalable to smaller dimensions along the lines of Lego®-style building blocks, for example.

### SUMMARY OF THE INVENTION

In accordance with one aspect of the present invention, there is provided a child's construction toy having a first construction unit with a first matrix of assembly members, wherein the first matrix has at least one square aperture and at least one additional assembly member selected from the group consisting of notches, slots, tabs, square apertures, circular apertures, oblong recesses, and tapered oblong recesses, wherein the at least one additional aperture includes at least one circular aperture. The toy further having a second construction unit having a second matrix of assembly members, wherein the second matrix comprises at least one tab and at least one additional assembly member selected from the group consisting of notches, tabs, slots, square apertures, circular apertures, oblong recesses, and tapered oblong recesses, and a third construction unit adapted to fit within the at least one circular aperture of the first construction unit. Wherein when one of the at least one tabs of the second construction unit is placed within one of the at least one square apertures of the first construction unit at least some of the remaining assembly members of the first construction unit and second construction unit align and the third construction unit partially fits within the at least one circular aperture of the first construction unit.

The first matrix of assembly members may be spaced at even intervals, such as 1.5-inches on center.

The first construction unit may include ten notches, eight square recesses, and three circular recesses.

The second construction unit may include four oblong recesses, eight tabs, and two tapered oblong recesses.

The first construction unit may have ten notches, eight square recesses, and three circular recesses and the second construction unit may have four oblong recesses, eight tabs, and two tapered oblong recesses. In addition, four of the eight tabs of the second construction unit may be adapted to simultaneously fit within four of the eight square recesses of the first construction unit.

The first construction unit may have two square apertures and a circular aperture, the square apertures being spaced apart by 3-inches on center in the matrix and the circular aperture being spaced 1.5-inches on center from each square aperture.

The toy may further include a fourth construction unit, the fourth construction unit being identical to the first construction unit and being adapted such that the third construction unit fits partially within a circular aperture thereof. If so provided, the first construction unit and the fourth construction unit may each be planar, and may be adapted to lay against each other when the third construction unit is placed in each.

The toy may further include a fourth construction unit, the fourth construction unit being identical to the first construction unit and adapted such that a second of the at least one tabs of the second construction unit located opposite the first of the at least one tabs may be placed within one of the at least one square apertures of the fourth construction unit such that the first construction unit, second construction unit, and fourth construction unit establish a freestanding structure. So adapted, the first, second, and fourth construction units may all be planar, and the first and fourth construction units may be arranged parallel to each other with the second construction unit spanning the two in a perpendicular arrangement so as to form an I-shaped structure when viewed from one side. The toy may further have fifth and sixth construction units, the fifth and sixth construction units being adapted to fit within the freestanding structure between the first and fourth construction units and across the second construction unit to further brace the freestanding structure. So provided, the second construction unit may include at least two oblong recesses and each of the fifth and sixth construction units may include at least one corresponding oblong recess each, two of the at least two oblong recesses of the second construction unit being adapted to mate with the oblong recesses of the fifth and sixth construction units to connect the three units.

The toy of claim 10, wherein two sets of first, second, fourth, fifth, and sixth construction units, both assembled into separate freestanding structures, may be linked together by the third construction unit.

As discussed above, the toy may further include a fourth construction unit, the fourth construction unit being identical to the first construction unit and adapted such that a second of the at least one tabs of the second construction unit located opposite the first of the at least one tabs may be placed within one of the at least one square apertures of the fourth construction unit such that the first construction unit, second construction unit, and fourth construction unit establish a freestanding structure. So adapted, the first, second, and fourth construction units may all be planar, and the first and fourth construction units may be arranged parallel to each other with the second construction unit spanning the two in a perpendicular arrangement so as to form an I-shaped structure when viewed from one side. If provided as such, a third set of first, second, fourth, fifth, and sixth construction units may be linked together by a seventh construction unit. The seventh construction unit may be identical to the third construction unit.

The third construction unit may be selected from the group consisting of nails, bolts, and pins. The pin may be planar. The nail may include a head and a shaft extending therefrom, the shaft further including a series of ribs, each spanning less than the total circumference of the nail.

In accordance with other aspects of the present invention, a wrench may include a working end having a shaped open area, a handle attached to the working end, a stop associated with the shaped open area, the stop adapted to prevent the working end from sliding past the head of a conventional bolt.

The stop may be located adjacent the shaped open area.

The wrench may further have at least one additional stop, the at least one additional stop also adapted to prevent the working end from sliding past the head of a conventional bolt.

In accordance with a still further aspect of the invention, a kit of component parts for a child's construction toy may include a first construction unit having a first matrix of at least three evenly spaced assembly members selected from the group consisting of notches, tabs, square apertures, circular apertures, oblong recesses, and tapered oblong recesses, a second construction unit having a second matrix of at least three evenly spaced assembly members selected from the group consisting of notches, tabs, square apertures, circular apertures, oblong recesses, and tapered oblong recesses, and a third construction unit adapted to connect the first construction unit to the second construction unit, wherein the first construction unit and the second construction unit do not touch.

The third construction unit may include a first matrix of at least three evenly spaced assembly members corresponding to the at least three evenly spaced assembly members of the first construction unit and a second matrix of at least three evenly spaced assembly members corresponding to the at least three evenly spaced assembly members of the second construction unit.

### BRIEF DESCRIPTION OF THE DRAWINGS

The subject matter regarded as the invention is particularly pointed out and distinctly claimed in the concluding portion of the specification. The invention, however, both as to organization and method of operation, together with the features, objects, and advantages thereof, will be or become apparent to one with skill in the art upon reference to the following detailed description when viewed with the accompanying drawings. It is intended that any additional organizations, methods of operation, features, objects, or advantages ascertained by one skilled in the art be included within this description, be within the scope of the present invention, and be protected by the accompanying claims.

In regard to the drawings, FIG. 1A depicts a perspective view of a construction unit in the form of a single block top;

FIG. 1B depicts a top view of the single block top of FIG. 1A (the bottom view being identical);

FIG. 1C depicts a side view of the single block top of FIG. 1A (the other side views being identical);

FIG. 2A depicts a perspective view of a construction unit in the form of a double block top;

FIG. 2B depicts a top view of the double block top of FIG. 2A (the bottom view being identical);

FIG. 2C depicts a side view of the double block top of FIG. 2A (the other side view being identical);

FIG. 2D depicts an end view of the double block top of FIG. 2A (the other end view being identical);

FIG. 3A depicts a perspective view of a construction unit in the form of a single I-beam;

FIG. 3B depicts a top view of the single I-beam of FIG. 3A (the bottom view being identical);

FIG. 3C depicts a side view of the single I-beam of FIG. 3A (the other side view being identical);

FIG. 3D depicts a first end view of the single I-beam of FIG. 3A;

FIG. 3E depicts a second end view of the single I-beam of FIG. 3A;

FIG. 4A depicts a perspective view of a construction unit in the form of a double I-beam;

FIG. 4B depicts a top view of the double I-beam of FIG. 4A (the bottom view being identical);

FIG. 4C depicts a first side view of the double I-beam of FIG. 4A;

FIG. 4D depicts a second side view of the double I-beam of FIG. 4A;

FIG. 4E depicts an end view of the double I-beam of FIG. 4A (the other end view being identical);

FIG. 5A depicts a perspective view of a construction unit in the form of a I-beam cross brace;

FIG. 5B depicts a top view of the I-beam cross brace of FIG. 5A (the bottom view being identical);

FIG. 5C depicts a side view of the I-beam cross brace of FIG. 5A (the other side view being identical);

FIG. 5D depicts a first end view of the I-beam cross brace of FIG. 5A;

FIG. 5E depicts a second end view of the I-beam cross brace of FIG. 5A;

FIG. 6A depicts a perspective view of a construction unit in the form of a pin clip;

FIG. 6B depicts a top view of the pin clip of FIG. 6a (the bottom view being identical);

FIG. 6C depicts a side view of the pin clip of FIG. 6a (the other side view being identical);

FIG. 6D depicts a first end view of the pin clip of FIG. 6A;

FIG. 6E depicts a second end view of the pin clip of FIG. 6A;

FIG. 7A depicts a perspective view of a construction unit in the form of a pin;

FIG. 7B depicts a top view of the pin of FIG. 7A (the bottom view being identical);

FIG. 7C depicts a side view of the pin of FIG. 7A (the other side view being identical);

FIG. 7D depicts an end view of the pin of FIG. 7A (the other end view being identical);

FIG. 8A depicts a perspective view of a construction unit in the form of a nail;

FIG. 8B depicts a top view of the nail of FIG. 8a;

FIG. 8C depicts a bottom view of the nail of FIG. 8A;

FIG. 8D depicts a first side view of the nail of FIG. 8A (the opposite side view being identical);

FIG. 8E depicts a second side view of the nail of FIG. 8A (the opposite side view being identical);

FIG. 9A depicts a perspective view of a construction unit in the form of a bolt;

FIG. 9B depicts a top view of the bolt of FIG. 9A;

FIG. 9C depicts a bottom view of the bolt of FIG. 9A;

FIG. 9D depicts a first side view of the bolt of FIG. 9A (the opposite side view being identical);

FIG. 9E depicts a second side view of the bolt of FIG. 9A (the opposite side view being identical);

FIG. 10A depicts a perspective view of a construction unit in the form of a nut;

FIG. 10B depicts a top view of the nut of FIG. 10A (the bottom view being identical);

FIG. 10C depicts a side view of the nut of FIG. 10A (the other side views being identical);

FIG. 11A depicts a perspective view of a construction unit in the form of a circle pin;

FIG. 11B depicts a top view of the circle pin of FIG. 11A (the bottom view being identical);

FIG. 11C depicts a side view of the circle pin of FIG. 11A (the other side view being identical);

FIG. 11D depicts a first end view of the circle pin of FIG. 11A;

FIG. 11E depicts a second end view of the circle pin of FIG. 11A;

FIG. 12A depicts a perspective view of a construction unit in the form of a rail;

FIG. 12B depicts a top view of the rail of FIG. 12A (the bottom view being identical);

FIG. 12C depicts a side view of the rail of FIG. 12A (the other side view being identical);

FIG. 12D depicts an end view of the rail of FIG. 12A (the other end view being identical);

FIG. 13A depicts a perspective view of a construction unit in the form of a rail;

FIG. 13B depicts a top view of the rail of FIG. 13A (the bottom view being identical);

FIG. 13C depicts a side view of the rail of FIG. 13A (the other side view being identical);

FIG. 13D depicts an end view of the rail of FIG. 13A (the other end view being identical);

FIG. 14A depicts a perspective view of a construction unit in the form of a rail;

FIG. 14B depicts a top view of the rail of FIG. 14A (the bottom view being identical);

FIG. 14C depicts a side view of the rail of FIG. 14A (the other side view being identical);

FIG. 14D depicts an end view of the rail of FIG. 14A (the other end view being identical);

FIG. 15A depicts a perspective view of a construction unit in the form of a triangle truss;

FIG. 15B depicts a top view of the triangle truss of FIG. 15A (the bottom view being identical);

FIG. 15C depicts a side view of the triangle truss of FIG. 15A (the other side view being identical);

FIG. 15D depicts a first end view of the triangle truss of FIG. 15A;

FIG. 15E depicts a second end view of the triangle truss of FIG. 15A

FIG. 16A depicts a perspective view of a construction unit in the form of a triangle truss leg;

FIG. 16B depicts a top view of the triangle truss leg of FIG. 16A (the bottom view being identical);

FIG. 16C depicts a first side view of the triangle truss leg of FIG. 16A;

FIG. 16D depicts a second side view of the triangle truss leg of FIG. 16A;

FIG. 16E depicts a third side view of the triangle truss leg of FIG. 16A;

FIG. 16F depicts a fourth side view of the triangle truss leg of FIG. 16A;

FIG. 17A depicts a perspective view of a construction unit in the form of a roof panel;

FIG. 17B depicts a top view of the roof panel of FIG. 17A (the bottom view being identical);

FIG. 17C depicts a side view of the roof panel of FIG. 17A (the other side view being identical);

FIG. 17D depicts an end view of the roof panel of FIG. 17A (the other end view being identical);

FIG. 18A depicts a perspective view of a construction unit in the form of a window;

FIG. 18B depicts a top view of the window of FIG. 18A (the bottom view being identical);

FIG. 18C depicts a side view of the window of FIG. 18A (the other side view being identical);

FIG. 18D depicts an end view of the window of FIG. 18A (the other end view being identical);

FIG. 19A depicts a perspective view of a construction unit in the form of a steering wheel;

FIG. 19B depicts a top view of the steering wheel of FIG. 19A (the bottom view being identical);

FIG. 19C depicts a first side view of the steering wheel of FIG. 19A;

FIG. 19D depicts a second side view of the steering wheel of FIG. 19A;

FIG. 19E depicts an end view of the steering wheel of FIG. 19A (the other end view being identical);

FIG. 20A depicts a perspective view of a hammer handle;

FIG. 20B depicts a front view of the hammer handle of FIG. 20A (the rear view being identical);

FIG. 20C depicts a first side view of the hammer handle of FIG. 20A (the second side view being identical);

FIG. 20D depicts a top end view of the hammer handle of FIG. 20A;

FIG. 20E depicts a bottom end view of the hammer handle of FIG. 20A;

FIG. 21A depicts a perspective view of a hammer disk;

FIG. 21B depicts a top view of the hammer disk of FIG. 21A (the bottom view being identical);

FIG. 21C depicts a side view of the hammer disk of FIG. 21A;

FIG. 22A depicts a perspective view of a wrench handle;

FIG. 22B depicts a rear view of the wrench of FIG. 22A;

FIG. 22C depicts a front view of the wrench of FIG. 22A;

FIG. 22D depicts a first side view of the wrench of FIG. 22A (the second side view being identical);

FIG. 22E depicts a top end view of the wrench of FIG. 22A;

FIG. 22F depicts a bottom end view of the wrench of FIG. 22A;

FIG. 23A depicts a perspective view of a basic building unit formed from various construction units;

FIG. 23B depicts a front view of the building unit of FIG. 23A (the rear view being identical);

FIG. 23C depicts a first side view of the building unit of FIG. 23A (the second side view being identical);

FIG. 23D depicts a top end view of the building unit of FIG. 23A;

FIG. 23E depicts a bottom end view of the building unit of FIG. 23A

### DETAILED DESCRIPTION

In describing the preferred embodiments of the subject matter illustrated and to be described with respect to the drawings, specific terminology will be resorted to for the sake of clarity. However, the invention is not intended to be limited to the specific terms so selected and it is to be understood that each specific term includes all technical equivalents which operate in a similar manner to accomplish a similar purpose.

It will be appreciated that aspects of the present invention include construction units that may be configured so as to be built into a child's toy. The construction units may include assembly members, either in matrices or not, where the assembly members are selected from the group consisting of notches, slots, tabs, apertures (preferably square apertures or circular apertures), oblong recesses, and tapered oblong recesses, among other similar and other geometric and non-geometric constructs.

The matrices of each construction unit, if provided, are preferably arranged on a consistent grid such that they align with matrices of other construction units in a known pattern regardless of the relative location of one construction unit with respect to another. In other words, because of the consistent matrix, it is not necessary that one construction unit be stacked or otherwise mated to another construction unit at a single particular location. Rather, one construction unit may be shifted relative the other construction unit such that it is mated in one of the next available matrix locations.

Furthermore, the matrices contemplated by this invention may be presented in multiple planes. The majority of construction units contemplated are planer. In such cases, one plane may be along the flat horizontal upper and lower surfaces of a construction unit. Another plane may be along the vertical ends or sides of a construction unit. In this regard, construction units may be stacked end to end, side to side, side to end, end to side, upper surface to lower surface, etc., creating a variety of options for the user.

With respect to the construction units, it is to be understood that such units may be constructed of a variety of materials, such as various plastics, metals, woods, and the like. Notwithstanding, it is preferable that the construction units be configured from resilient material including compositions made from substantially closed-cell cross-linked polyethylene foam.

In preferred embodiments, the construction units are comprised of three “layers” of such foam, with the top and bottom “layers” having a foam density of approximately five to six pounds per cubic feet and the central layer having a foam density of approximately one to two pounds per cubic feet. Typically, the top and bottom “layers” may have a thickness of ⅛-inch to 3/16-inch while the central core has a thickness of ½-inch to ⅝-inch thick. Such configurations are known in the industry and provide for material that is resilient and somewhat soft, such that is appropriate for use by children, but also provides a relatively high level of structural support and rigidity. Of course, it is to be understood that the ranges provided are exemplary only, and as other ranges are also contemplated the invention should not be considered so limited. Specifically, the inventive construction units may be scalable to larger or smaller dimensions. In addition, certain construction units may be formed from only a single layer of material, either that similar to the top and bottom “layers” introduced above, the central core, also introduced above, or other formulations or thicknesses. The term “layer” used herein shall not be construed so as to limit construction units as being formed by three separate layers which are later glued or otherwise mated, but is inclusive of products where the “layers” are formed simultaneously in the production process, as known in the foam arts.

As with the thicknesses addressed above, the various construction units may be sized to a multitude of dimensions. Typically, such dimensions will be sufficient such that a finished product created by the construction units may be occupied or otherwise used in a “life-like” setting by a child. For example, it is contemplated, as will be discussed, that the units may be utilized to form a play house that a child can enter. In this regard, the individual units will preferably be dimensioned in terms of feet, such as 1 ft.×1 ft. or 1 ft.×1.5 ft, with some units extending to multiples thereof, for example 3 ft.×5 ft. Because the units are scalable, other embodiments of the invention may call for the units to be reduced in size, such as by ⅛ scale, ¼ scale, or ½ scale.

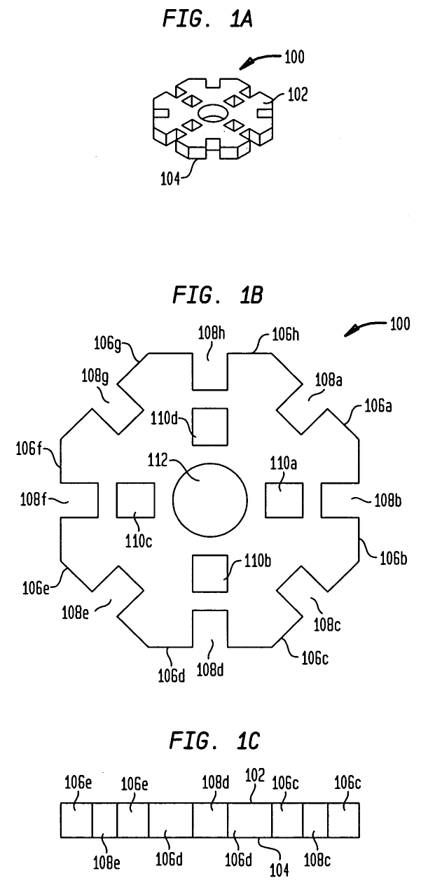

Moving to descriptions of exemplary construction units, and starting with the single block top element shown in FIGS. 1A-1C, one may begin to see the general configuration of some of the construction units and possible elements that comprise the matrices. As shown in FIG. 1A, a perspective view of the single block top 100, the single block top may be configured as a regular convex polygon with seven sides in the form of a hexagon. The single block top 100 may include a top 102 and a bottom 104, along with the seven sides 106a-106h. In the example shown herein, each side 106-106h includes a notch 108a-108h at the midpoint of such side. In other variations, the notches may be located at other positions, although it is preferred that the notches follow some preset pattern such that a matrix is established. The notches 106a-106h are configured as squares, but may also be configured to other geometric rectilinear shapes as well as non-geometric shapes, for example other shapes or less than complete construction through the thickness.

In this particular example, the single block top 100 further includes square apertures 110a-110c extending through its entire thickness. Further, in the central portion of the single block top, a circular aperture 112 is found also extending through the entire thickness. Again, other configurations are possible.

Regardless of the other configurations, it will be appreciated that the circular aperture 112 and a square apertures 110a-110d, as well as the notches 108a-108h, all form a common matrix having even spacing in this example. In this regard, although those components may be different in size, for example, the square apertures 110a-110d being smaller in size than the circular aperture 112, it will be appreciated that each of the assembly members found on the matrix include a central point on the matrix grid. For purposes of this invention, it will be appreciated that the matrix grid may be any convenient spacing desired. However, common spacing include those in the range of 1-inch to 3-inches on center with the most preferable spacing being 1.5-inches on center. Of course, as the construction units are scaled larger or smaller, such as 2×, 4×, ¼, ½ scale, the matrix spacing can be similarly adjusted. It will also be readily apparent that given a particular spacing, the assembly members must be conformingly sized. For example, a 1-inch diameter circular aperture would fit nicely in a matrix sized 1.5-inches on center, whereas a 4-inch diameter circular aperture would not.

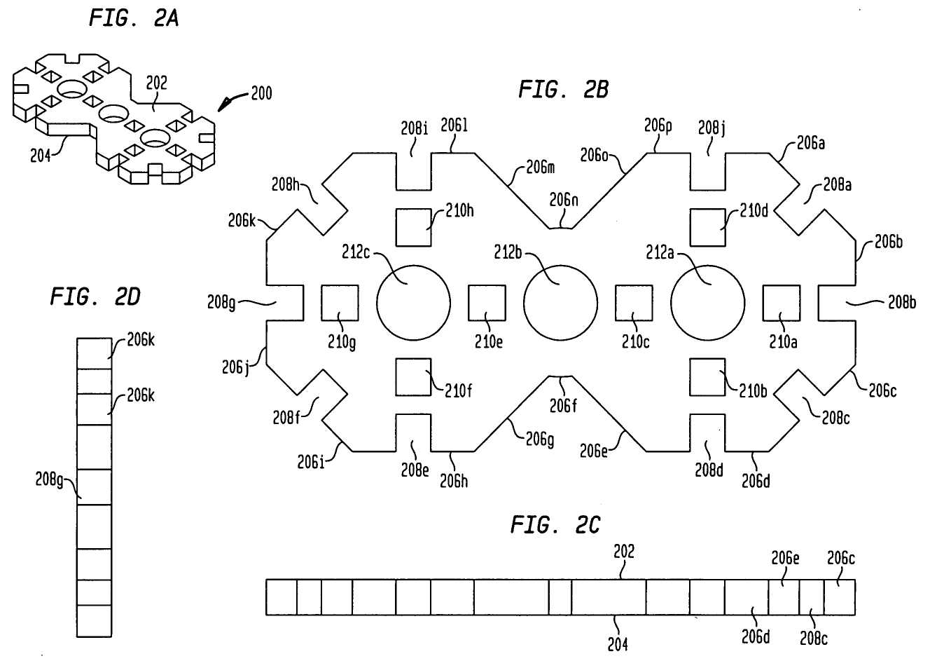

Moving beyond the single block top 100, embodiments of the invention may also include a construction unit in the form of a double block top, shown in FIGS. 2A-2D. It will be immediately apparent that the double block top 200 is in many respects simply two single block tops 100 combined. In this regard, the double block top includes a top 202 and a bottom 204, much like the single block top 100. The double block top 200 also includes sides 206a-206p, but in this case the sides form an irregular polygon (sides 206b and 206j may also be referred to as ends). In this particular instance, the double block top 200 includes sixteen sides 206a-206p. Sides 206a-206d, 206h-206l, and 206p include notches 208a-208j, preferably in the form found in the single block top 100 to continue a matrix. Likewise, double block top 200 includes a matrix of square apertures 210a-210h and circular apertures 212a-212c extending through the thickness of the construction unit. Again, it will be appreciated that such assembly members may vary from those shown and the configuration shown.

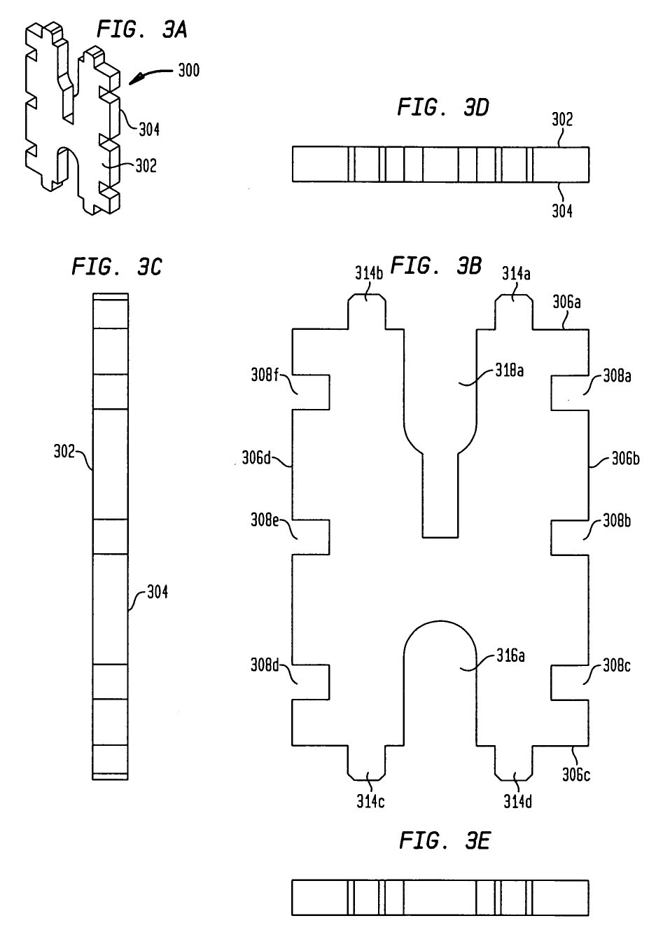

Another construction unit in the form of a single I-beam 300 is shown in FIGS. 3A-3E. As with the single block top 100 and double block top 200 shown, the single I-beam 300 is a planar piece with assembly members formed along the matrix. The single I-beam 300 embodied by FIGS. 3A-3d includes a top 302 and bottom 304. It also includes sides 306a-306d in the general shape of a rectangle as shown most clearly in the top view of FIG. 3B (sides 306a and 306c may also be referred to as ends). Included in sides 306b and 306d are a series of notches 308a-308f, while sides 306a and 306c include tabs 314a-314d. On side 306c, and configured centrally between tabs 314c and 314d, the single I-beam 300 includes an oblong recess 316a, the oblong recess being a generally arcuate opening with linear sides extending to the side 306c. On side 306a, and configured centrally between tabs 314a and 314b, the single I-beam includes a tapered oblong recess 318a. The tapered oblong recess 318a generally includes a first portion which matches the configuration of the oblong recess 316a and further includes a narrower extension tapering toward the geometric center of the single I-beam 300.

It will be appreciated that the various notches 308a-308f, tabs 314a-314d, and recesses, both oblong 316a and tapered oblong 318a, each fall in a matrix with consistent spacing. Preferably, the spacing matches the spacing of the matrices found in the other construction units such as the single block top 100. Because of such even spacing and corresponding sizes, and as will be discussed further below, tabs 314a and 314b may be placed within square apertures 110a-110c of single block top 100 as they align in an upper surface to end configuration. Furthermore, this procedure in the exemplary embodiments would align circular aperture 112 with tapered oblong recess 318a.

Other mating configurations may also be realized. For example, although not simultaneously, each of the tabs 314a-d of the single I-beam 300 are expected to conveniently mate with the notches 108a-108h of the single block top 100, notches 208a-208j of the double block top 200, and notches of other construction units contemplated by the invention in an end to end relation. It would therefore be appreciated that the various construction units may be connected by their assembly members in a manner which is heretofore unknown, and which provides virtually endless opportunities for mating the various construction units. Further examples will be discussed below.

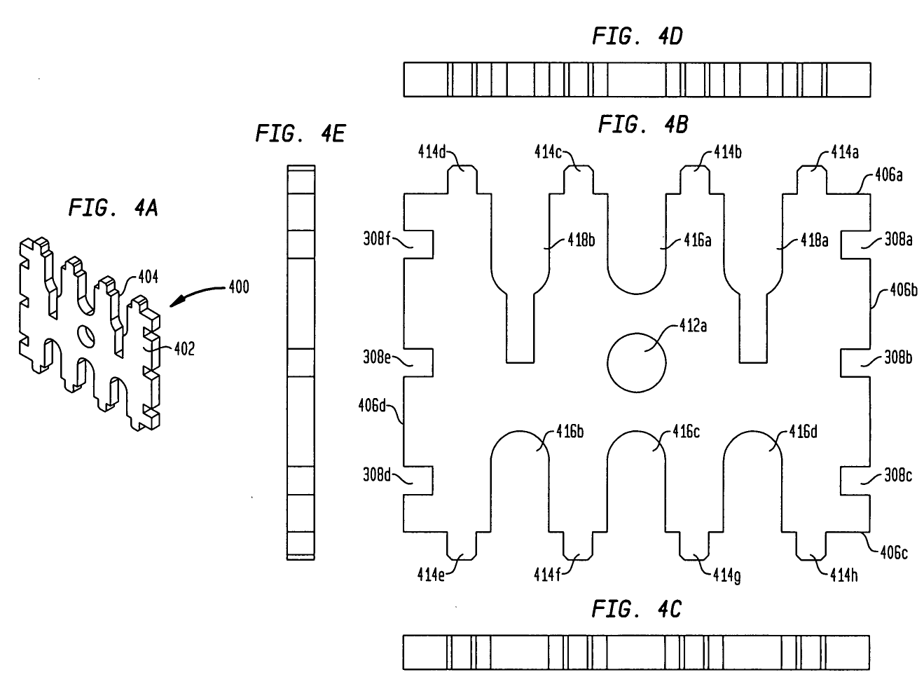

Other construction units may be formed in a manner similar to the I-beam in a fashion similar to the expansion of the single block top 100 into the double block top 200. For example, a double I-beam 400 may be provided, as shown in FIGS. 4A-4E.

As with the other construction units discussed thus far, the double I-beam 400 is a generally planer with a top 402 and bottom 404. The double I-beam 400 also includes four sides 406a-406d. In this particular arrangement, sides 406b and 406d match sides 306b and 306d of the single I-beam 300 in that may include notches 308a-308f aligned along a matrix.

Similarly, sides 406a and 406c generally match the configurations of sides 306a and 306c, but are double the length and include additional oblong recesses. More specifically, sides 406a and 406c include tabs 414a-414h. Side 406a also includes tapered oblong recesses 418a and 418b separated by oblong recess 416a. Side 406c simply includes three recesses 416b-416d separated by the respective tabs 414e-414h. In generally the center of the double I-beam, there is a circular aperture 412a. It will be appreciated that, along with the other assembly members, the circular aperture 412a is arranged within the matrix.

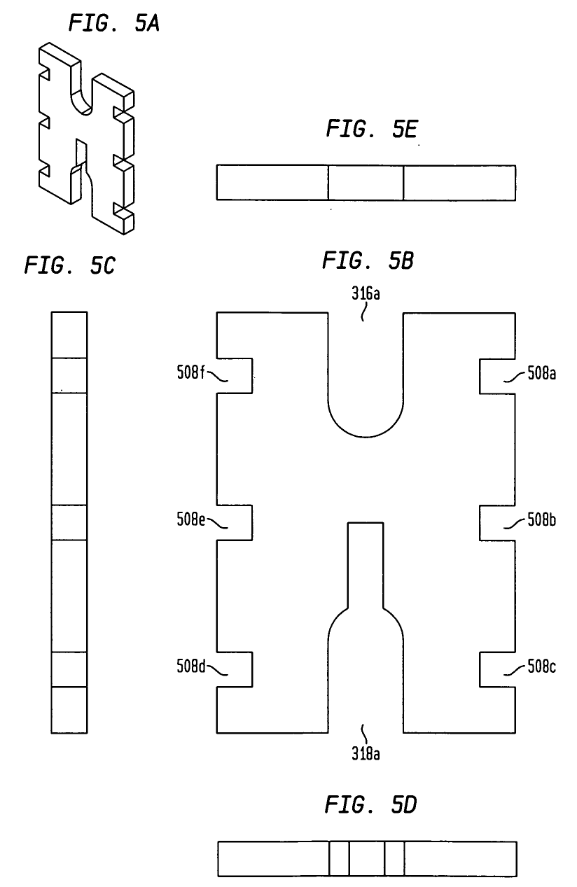

The next exemplary construction unit shown is the I-beam cross brace 500 of FIGS. 5A-5E. It will be appreciated from viewing that the exemplary I-beam cross brace 500 includes each of the features of the single I-beam 300, including notches 508a-508f, recess 516a, and oblong recess 518a, with the exception of the tabs 314. From this example, one skilled in the art will ready understand that the construction units shown and described herein are merely exemplary, and the various assembly members included with each may be different than shown. As a further example, the I-beam cross brace of FIG. 5A could be configured with two tabs, less than the six notches 508b shown, an aperture (whether circular, square, or otherwise), etc. Other examples are too numerous to discuss specifically.

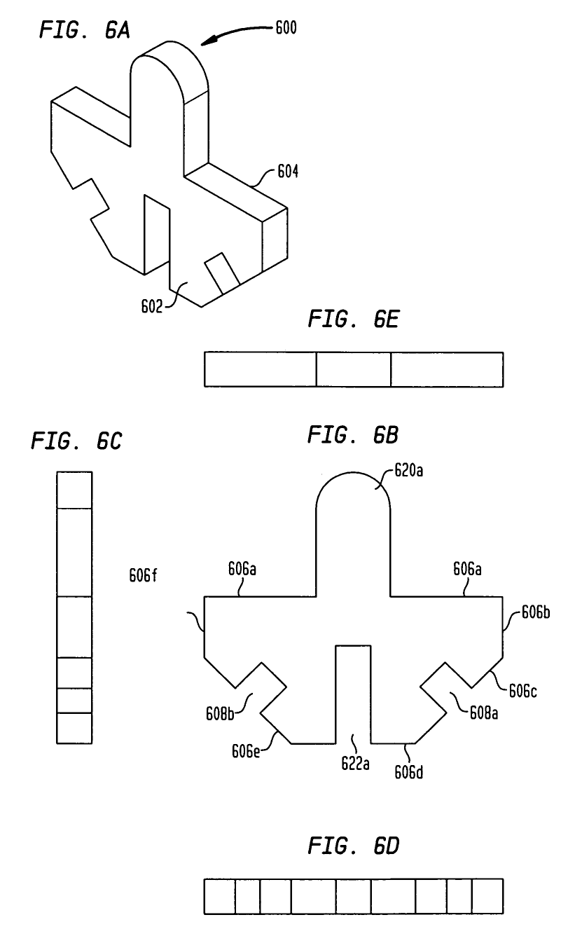

Another construction member contemplated by the invention is a pin clip 600, as shown in FIGS. 6A-6E. As shown, the pin clip 600 is generally planer with a top 602 and bottom 604. The exemplary pin clip 600 is a six sided 606a-606f figure with an oblong extension 620a extending out of its longest side 606a. Preferably, the oblong extension 620a matches the configuration of the oblong recesses previously discussed, such as oblong recess 316a.

The exemplary pin clip 600 also includes notches 608a, 608b in sides 606c and 606e. Extending into side 606d is a slot 622a. The slot 622a preferably has a width approximately equal to the notches 606a, 606b, but a longer length. Most preferably, the width of slot 622a equals the thickness of the planar construction units, such that a planar construction unit may be slid within the slot from the side to form a cross pattern with the planar pin clip.

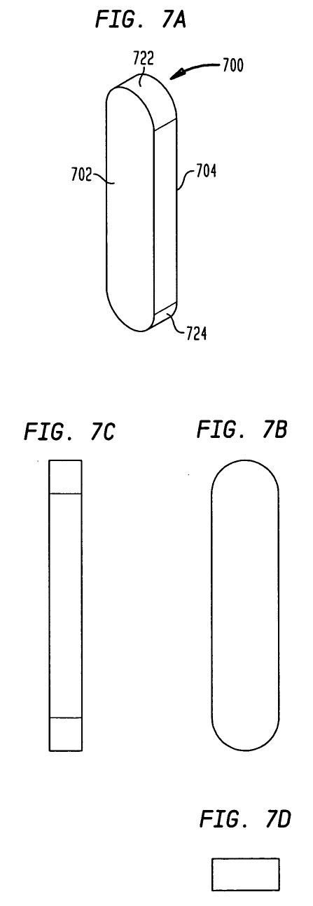

Another construction unit contemplated is the pin 700 shown in FIGS. 7A-7D. The pin 700 is preferably formed of oblong geometry, and is also planar. The pin includes rounded ends 722a and 722b connected by an elongate portion 724. Preferably, the pin 700 is sized and configured such that either of the rounded ends 722a, 722b fit snugly within oblong recesses or tapered oblong recesses of other construction units. It will thereby be appreciated that two construction units may be joined by placing them nearly end to end, with opposed recesses, and thereafter inserting a first rounded end 722a of a pin 700 into one construction unit and a second rounded end 722b of the pin into the recess of the other construction unit.

In addition, the pin 722 is also shaped to fit snugly within the circular apertures of other construction units. In this regard, the pin 700 may be inserted into the aperture perpendicularly to the planar construction unit. It will be appreciated that two planar surfaces, such as two double block tops 200, may thereby be joined as the top 202 of one mates against the bottom 204 of another, with one or more pins 700 connecting aligned circular apertures (any one or more of 212a-212c of one to any one or more of 212a-212c of another). Such alignment of circular apertures 212a-212c may be offset, such that circular aperture 212a of one double block top 200 aligns with circular aperture 212c of another. Further the connected double block tops 200 may be aligned linearly, or may be angled relative to each other, such that, for example, an angle is formed by the lines passing through the circular apertures 212a-212c of the respective double block tops.

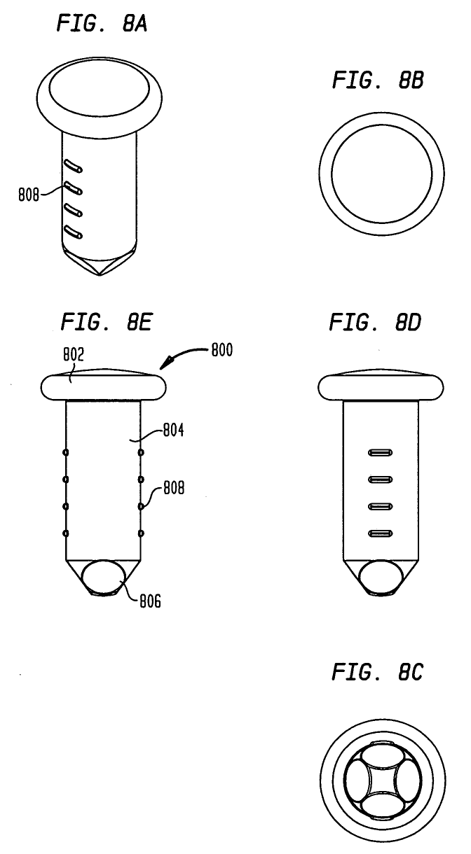

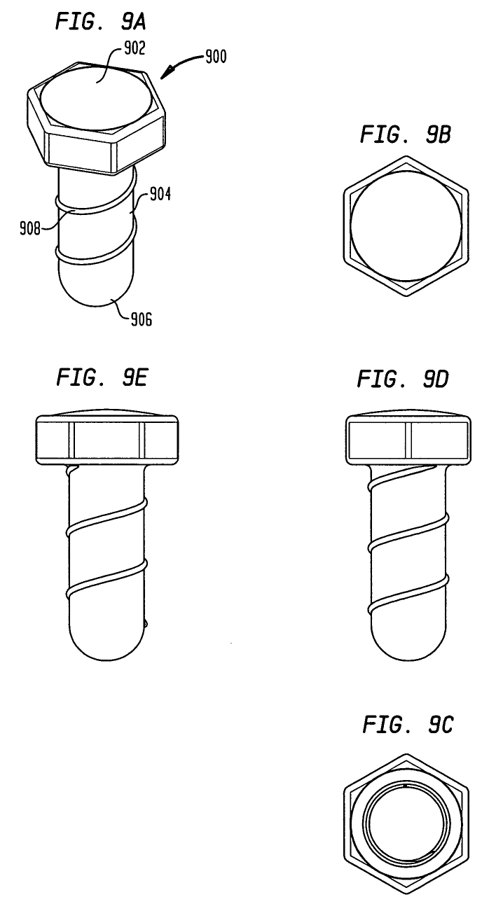

Moving along with further construction units, also contemplated by the invention are nails, bolts, and nuts, each described in turn herein. Nails, shown in FIGS. 8A-8E, and bolts, shown in FIGS. 9A-9E, may be constructed of hard plastic to provide a greater rigidity than would be permitted with use of the aforementioned foam materials. Of course, such construction units may also be configured of foam or other material as well.

The nails 800 may include a circular nail head 802 resting upon a shaft 804 having a point 806, as is fairly conventional. Preferably, the shaft 804 has a diameter approximately equal to (or just smaller than) the diameter of the circular apertures of the other construction units, such that the shaft may fit therein in a somewhat tight friction fit. To help maintain the nail in such position, the nail may be configured with a serious of ribs 808. The ribbing 808 may encircle the entire shaft circumference, or only a part of the circumference as shown in FIGS. 8A-8E. Rather than ribs 808, the nail may also be configured with raised bumps or other surface imperfections to increase the friction between the nail and the construction unit into which it is placed.

Like the nail, the bolt 900, shown in FIGS. 9A-9E may include a head 902 resting upon a shaft 904. In the case of the bolt 900, the shaft may terminate in a rounded end 904, rather than a point. In addition, the head 902 may be configured as a polygon to allow mating with a rotation device such as a wrench. Preferably, the head 902 is shaped as a hexagon with six sides, as shown. The bolt shaft 904 may include helically wound threads 908. Preferably, such threads 908 are self tapping, such that they may “bite into” the resilient aperture of a construction unit, such as a properly sized circular aperture.

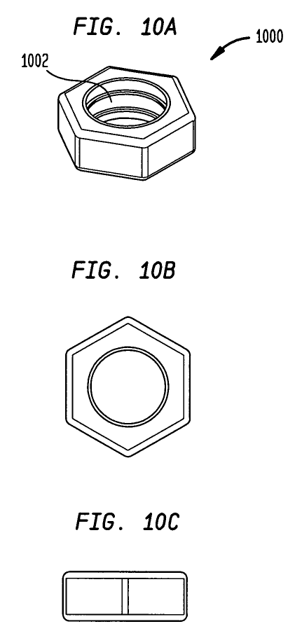

FIGS. 10A-10C depict various views of a nut 1000 which may accompany the other construction units in the invention, particularly the bolt 900. The nut 1000 is preferably configured as a polygonal disk with a circular central aperture 1002, much like a conventional bolt. Preferably, the polygonal shape is that of a hexagon. It will be appreciated that the circular central aperture 1002 is preferably sized to mate with the shaft 904 of bolt 900 in a friction fit relation or in a relation whereby the threads 908 of the bolt 900 “bite into” nut 1000 in the case of a nut formed from resilient material, such as foam. Other materials may include various plastics, such as those that may form the nail 800 and bolt 900.

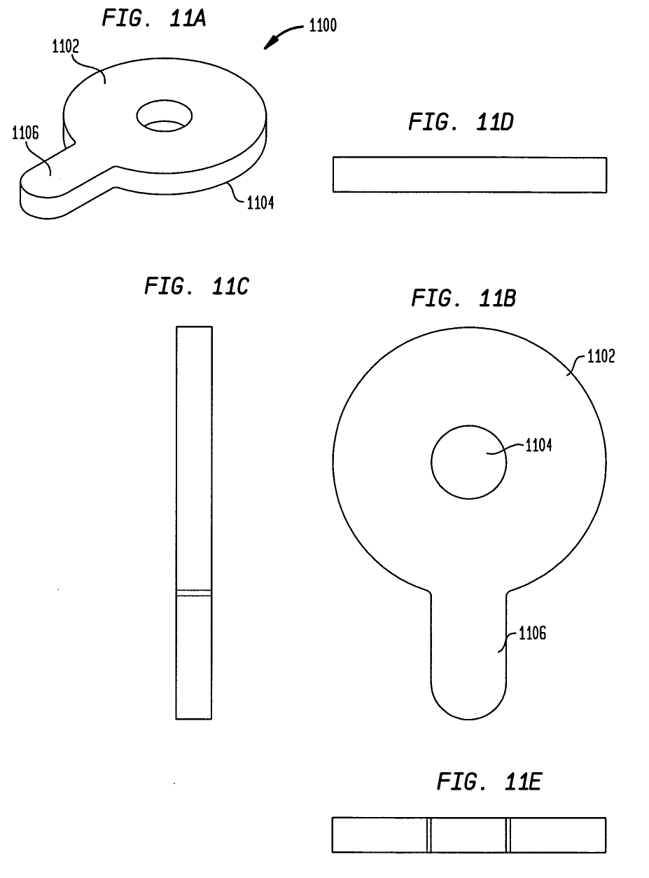

A still further construction unit that may be utilized in the invention is a circular pin 1100, such as that shown in FIGS. 11A-11E. The circular pin 1100 includes a disk portion 1102 with a circular aperture 1104. Preferably, the circular aperture 1104 is sized to snugly accommodate pins 700, nails 800, and bolts 900. Further, the circular pin includes an oblong extension member 1106. The oblong extension member 1106 is preferably sized and configured to the approximate dimensions of a pin 700, at least in width, such that the oblong extension member may fit within the matrix of assembly members in a manner similar to that of the pin 700.

In this regard, the circle pin 1100 permits novel interconnection methods between various construction units. For example, the oblong extension member 1106 may be inserted into the circular aperture 112 of a single block top 100 such that the single block top and circle pin are mated in a perpendicular relation. The circular aperture 1104 of the circle pin 1100 may then be utilized for connecting other construction units, such as another single block top 100, with an assembly member such as a pin 700, nail 800, bolt 900, or even the a pin clip 600 using the oblong extension 620a.

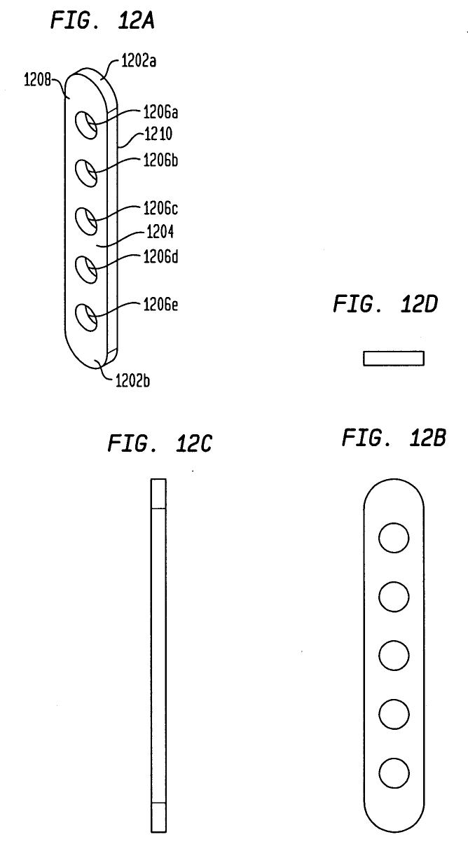

Other construction units include various rails, such as rail 1200 shown in FIGS. 12A-12D. Rails are configured as elongate members with a top surface 1208 and bottom surface 1210, and a series of apertures, preferably circular apertures. The rail 1200 shown in FIGS. 12A-12D includes a pair of rounded ends 1202a, 1202b with an elongate midsection 1204. Within the elongate midsection are disposed a series of circular apertures 1206a-1206e. Preferably, the apertures are evenly spaced along a matrix conforming to the matrix of other construction units in the set, and are sized equal to that of the circular apertures of those other construction units. In the case of the rail 1200 shown in FIGS. 12A-12D, the rail includes five (5) apertures.

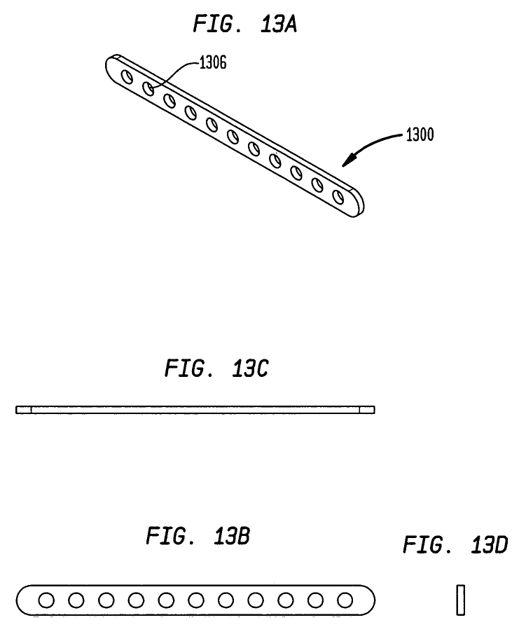

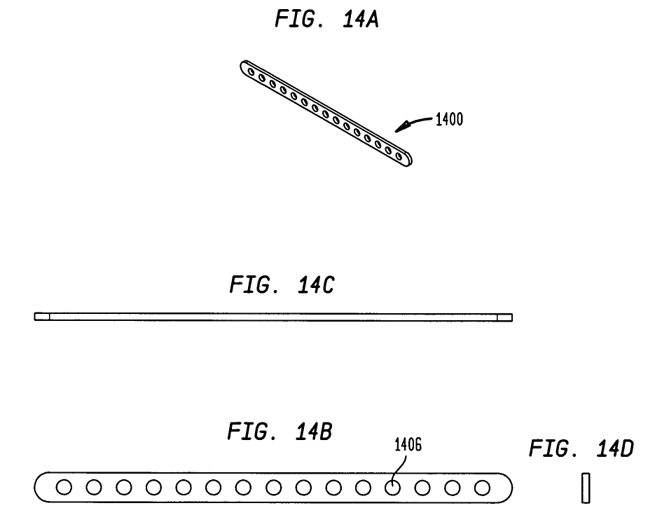

Other rails include additional apertures or less apertures. For example, rail 1300 shown in FIGS. 13A-13D includes eleven (11) apertures and rail 1400 shown in FIGS. 14A-14D includes fifteen (15) apertures. In exemplary embodiments, rail 1200 is 18-inches long, rail 1300 is 36-inches long, and rail 1400 is 48-inches long.

It will be appreciated that the rails may be utilized as connection members to connect one or more construction units to each other, typically by utilizing at least two (not necessarily two of the same) pins 700, nails 800, bolts 900, or pin clips 600 in at least two circular apertures of the rail, where the at least two pins 700, nails 800, bolts 900, or pin clips 600 connect two different construction units to the rail.

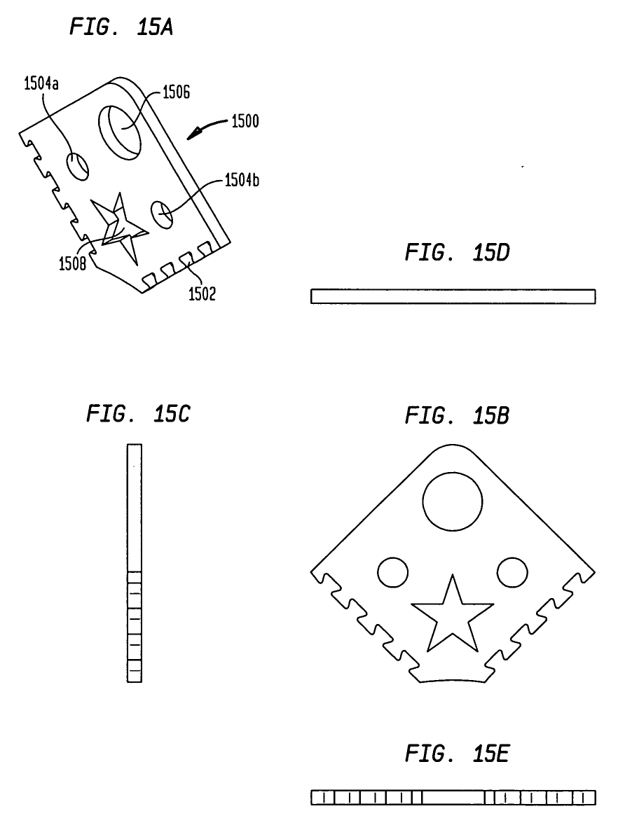

Construction units may also form other shapes, such as trusses. One such exemplary truss is shown in FIGS. 15A-15E as a triangle truss 1500. The triangle truss 1500 is generally square or diamond in shape and may include notches 1502 on one or more sides. It may also include apertures, such as circular apertures 1504a, 1504b, or oversized circular apertures 1506 (oversized being in relation to the standard size, matching the sizes of other construction units). Other apertures may form various shapes, such as the star aperture 1508 shown in FIGS. 15A-15D. For added strength, the notches 1502 of the triangle truss 1500 may be shaped such that the interior portions are wider than the exterior portions, such as in a dovetail configuration.

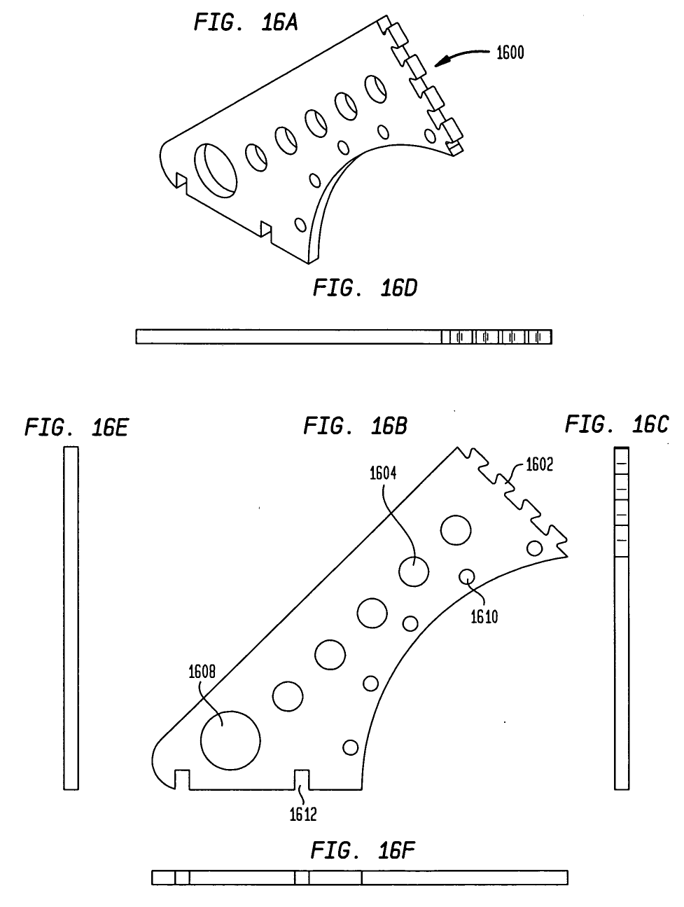

The length of the truss 1500 may be extended utilizing triangle truss legs 1600, shown in FIGS. 16A-16F Truss legs may be configured with tabs 1602 on at least one side, the tabs sized and configured to mate with the notches 1502 of the triangle truss 1500. The triangle truss legs may also include various apertures, such as circular apertures 1604, oversized circular apertures 1608, and undersized circular apertures 1610 (undersized being in relation to the standard size, matching the sizes of other construction units). Lastly, the truss legs 1600 may include notches 1612 to permit mating with other construction units.

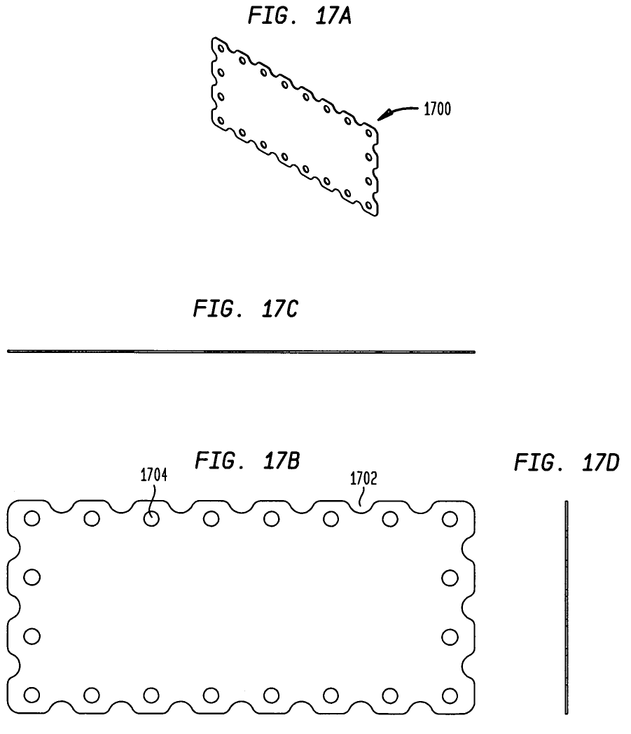

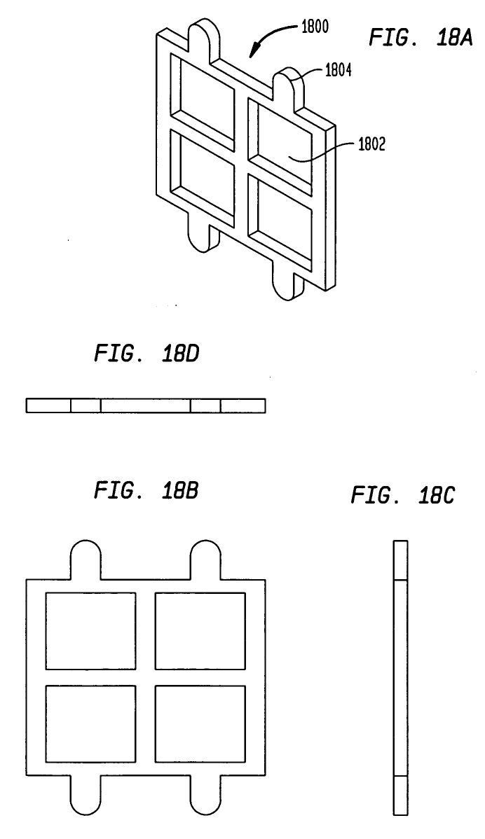

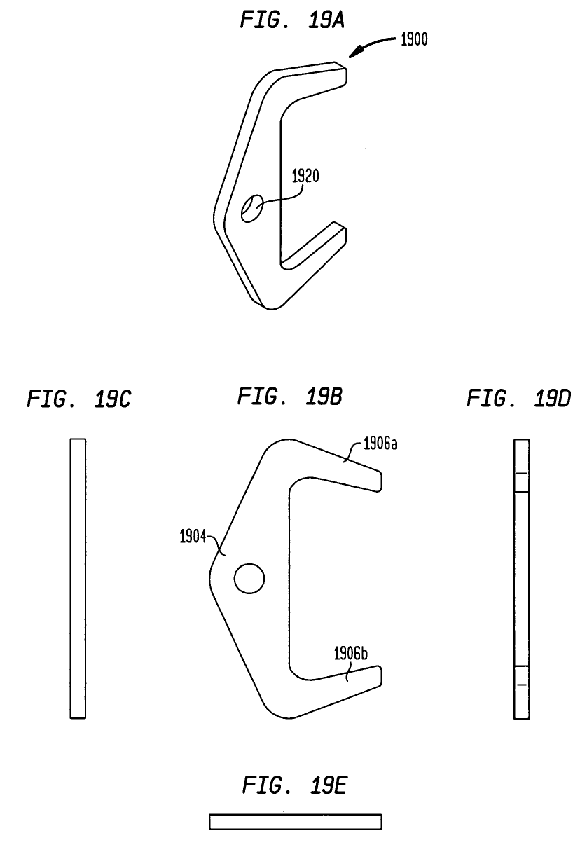

The remaining three construction units may be utilized as more specialized members than many of those previously discussed. These include the roof panel 1700 shown in FIGS. 17A-17D, the window 1800 shown in FIGS. 18A-18D, and the steering wheel 1900 shown in FIGS. 19A-19E.

Generally, the exemplary roof panel 1700 is a flat panel having scalloped edges and circular apertures 1704 configured along a matrix. The exemplary window 1800 is a square member having a plurality of square apertures 1802 through its interior and oblong tabs 1804 around the exterior. Lastly, the exemplary steering wheel 1900 is a U-shaped member having a central circular aperture 1902 passing through a base member 1904. Extending from the base member 1904 are two arms 1906a, 1906b, forming the legs (or arms) of the U-shape.

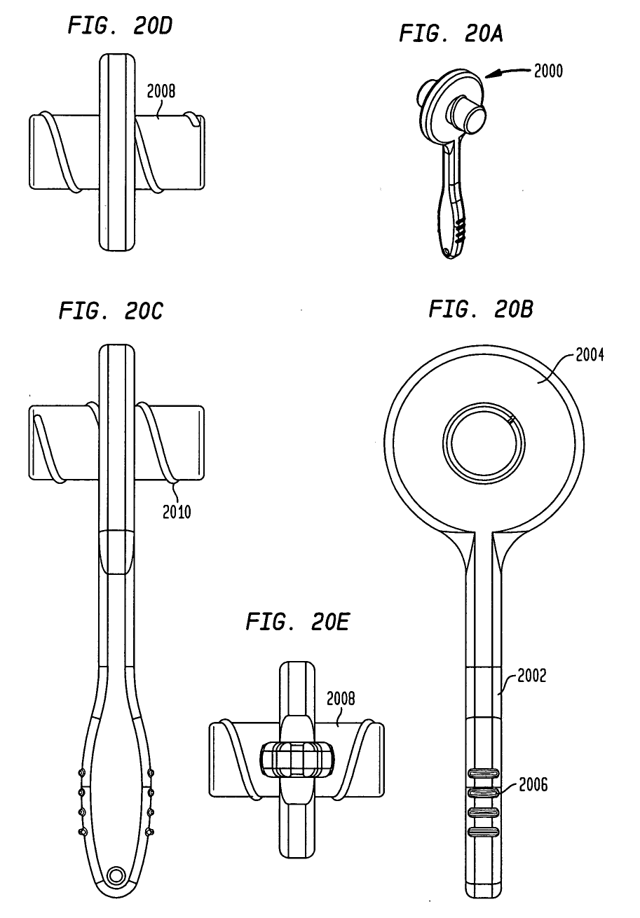

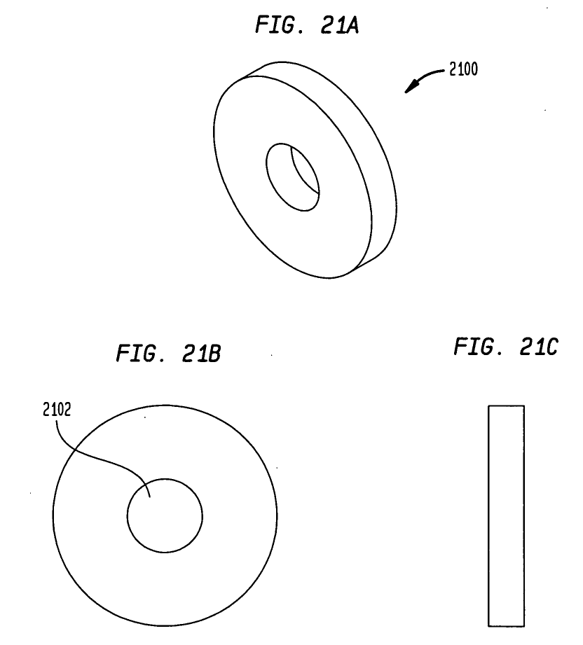

In order to assist the child with building the interlocking toy, various tools may be utilized. One such tool is a hammer. The exemplary hammer may be formed from the hammer handle 2000, shown in FIGS. 20A-20E and the hammer disk 2100, shown in FIGS. 21A-21D.

The exemplary hammer handle 2000 comprises a handle 2002 with a head 2004. The handle 2002 may include ribbing 2006 (or other surface imperfections) for better grip when held. Because the handle 2002 may also be sized to fit within an assembly member, such as an aperture, notch, or slot, of a construction unit for greater versatility in construction, the ribbing (or other surface imperfection) may assist with retaining the handle therein. The head 2004 is generally disk shaped, and includes a pair of projections 2008 extending away from each other. The projections each include threads 2010. The hammer disk 2100 is a circular disk shaped member with an aperture 2102. The aperture 2102 is sized and configured to fit over the projections 2008 to form the striking member of the hammer. Once configured as such, it will be appreciated that the predominant use of the hammer is to insert the nails. As discussed above, however, the hammer may also be used as a construction unit, for example forming the arms and hands of a robot or other imaginative application.

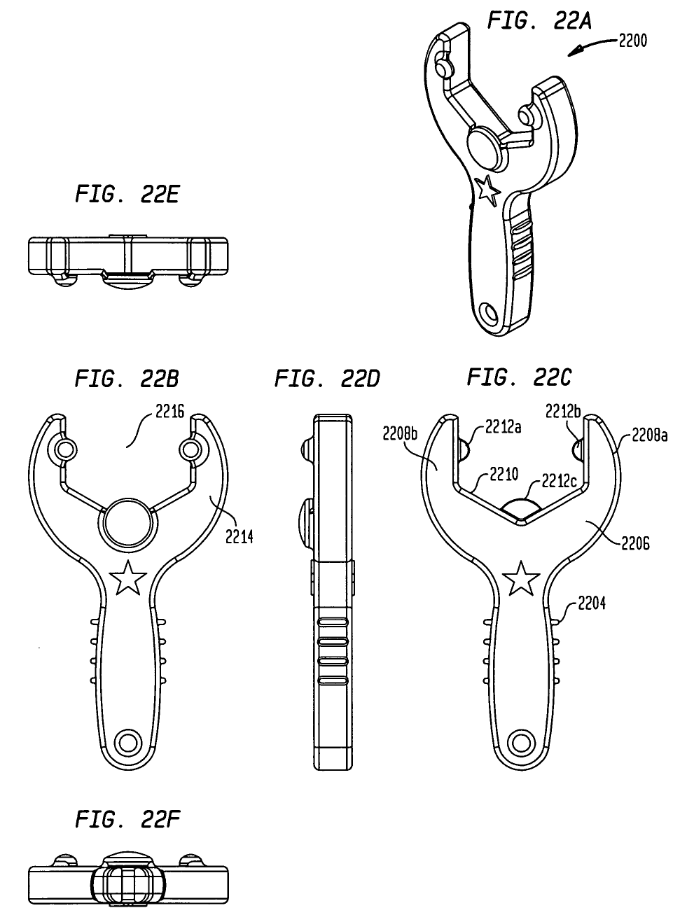

Another tool forming a portion of the present invention in certain embodiments is a wrench 2200 shown in FIGS. 22A-22F. The wrench 2200 includes a handle 2202 which may include ribs 2204 for gripping. The handle 2202 may also be configured similarly to the handle 2002 of the hammer 2000 so as to fit within an assembly member, or so as to be used as a construction unit. The handle 2202 extends to a working head 2206 formed from two arms 2208a, 2208b. The arms 2208a, 2208b (combined as working head 2206) include an interior surface 2210 forming a geometric shape, preferably that of a partial (or open) hexagon, much like a conventional wrench. In addition, the working head 2206 may include one or more stop members. In the exemplary embodiment shown, there are three such stop members 2212a-2212c. The stop members 2212a-2212c extend over a top surface 2214 of the wrench into the open area 2216 formed by the working head 2206.

It will be appreciated that when the wrench is utilized to turn a bolt, as in the case of bolt 900, the open working head 2206 may be slipped over the head 902 of the bolt and turned. If provided, stop members 2212a-2212c limit the wrench 2200 from slipping past the head 902 of the bolt 900 to a position adjacent the shaft 904, where the wrench would be rendered ineffective. This increases the usefulness of the wrench as one with undeveloped skills, such as a child, may still be able to use the wrench without having the head slip to an ineffective position.

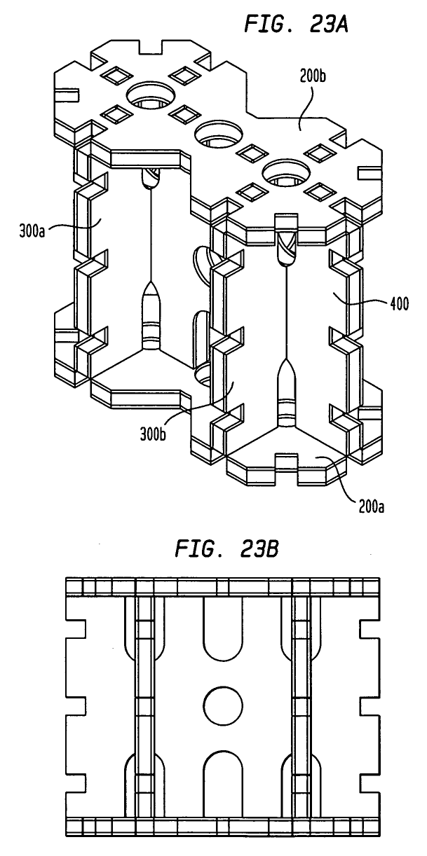

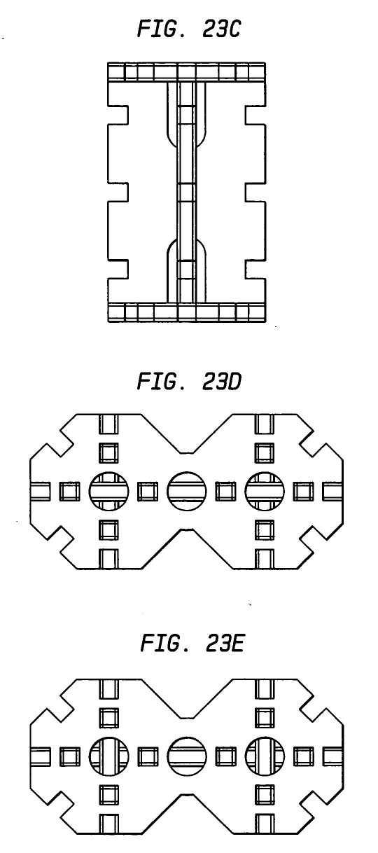

As discussed above, the various construction units may be utilized to build a variety of children's toys. In doing so, the construction units utilize the novel assembly member matrices discussed. Almost by definition, any disclosure could not exhaust the possible combinations of toys that may be constructed. However, in building toys utilizing the construction units of the present invention, it has been found that one basic building unit 2300 is particularly useful. The building unit 2300 is shown constructed in FIGS. 23A-23E, and is formed from two double block tops 200, two single I-beams 300, and one double I-beam 400.

As shown, a first double block top 200a may be placed flat. Two single I-beams 300a, 300b may then be placed adjacent to the first double block top 200a such that the tabs 314a, 314d of one of the single I-beams enter square apertures 210f and 210h of the double block top and tabs 314a, 314d of the other single I-beam enters square apertures 210b and 210d of the double block top. Thereafter, the double I-beam 400 may be slid over the two single I-beams (standing vertically against the horizontal double block top), with the tapered oblong recesses of the three construction units 318a (of each single I-beam), 418a, 418b connected. It will be appreciated that when completely driven home, the tabs 414a-414d of the double I-beam will enter square apertures 210a, 210c, 210e, and 210g of the double block top. The second double block top 200b may then follow, with each of its square apertures 210a-210h being filled by the tabs of the three vertical members, as shown in the figures.

It will be appreciated that in order to build large assemblies, building units, such as building unit 2300 shown in FIG. 23A, may be stacked. Using building unit 2300 as an example, a user may stack two units together such that double block top 200a of one unit is directly adjacent to double block top 200b of another unit. Preferably, a pin 700 may be placed through adjacent circular apertures of the adjacent double block tops 200a, 200b such that the pin serves to hold the units together. Additionally, for added strength in building, the building units 2300 may be offset in the manner typically provided for in brick laying, so no lengthy shear vertical faces are created.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A child's construction toy comprising:
a first construction unit having a first matrix of assembly members, wherein the first matrix comprises at least one square aperture and at least one additional assembly member selected from the group consisting of notches, slots, tabs, square apertures, circular apertures, oblong recesses, and tapered oblong recesses, wherein the at least one additional aperture includes at least one circular aperture;
a second construction unit having a second matrix of assembly members, wherein the second matrix comprises at least one tab and at least one additional assembly member selected from the group consisting of notches, tabs, slots, square apertures, circular apertures, oblong recesses, and tapered oblong recesses;
a third construction unit adapted to fit within the at least one circular aperture of the first construction unit;
wherein when one of the at least one tabs of the second construction unit is placed within one of the at least one square apertures of the first construction unit at least some of the remaining assembly members of the first construction unit and second construction unit align and the third construction unit partially fits within the at least one circular aperture of the first construction unit.

2. The toy of claim 1, wherein the first matrix of assembly members are spaced at 1.5 inches on center.

3. The toy of claim 1, wherein the first construction unit comprises ten notches, eight square recesses, and three circular recesses.

4. The toy of claim 1, wherein the second construction unit comprises four oblong recesses, eight tabs, and two tapered oblong recesses.

5. The toy of claim 1, wherein the first construction unit comprises ten notches, eight square recesses, and three circular recesses and the second construction unit comprises four oblong recesses, eight tabs, and two tapered oblong recesses, and wherein four of the eight tabs of the second construction unit are adapted to simultaneously fit within four of the eight square recesses of the first construction unit.

6. The toy of claim 1, wherein the first construction unit comprises two square apertures and a circular aperture, the square apertures being spaced apart by 3 inches on center in the matrix and the circular aperture being spaced 1.5 inches on center from each square aperture.

7. The toy of claim 1, further comprising a fourth construction unit, wherein the fourth construction unit is identical to the first construction unit and is adapted such that the third construction unit fits partially within a circular aperture thereof.

8. The toy of claim 7, wherein the first construction unit and the fourth construction unit are each planar, and are adapted to lay against each other when the third construction unit is placed in each.

9. The toy of claim 1, further comprising a fourth construction unit, wherein the fourth construction unit is identical to the first construction unit and is adapted such that a second of the at least one tabs of the second construction unit located opposite the first of the at least one tabs may be placed within one of the at least one square apertures of the fourth construction unit such that the first construction unit, second construction unit, and fourth construction unit establish a freestanding structure.

10. The toy of claim 9, wherein the first, second, and fourth construction units are all planar, and the first and fourth construction units are arranged parallel to each other with the second construction unit spanning the two in a perpendicular arrangement so as to form an I-shaped structure when viewed from one side.

11. The toy of claim 10, further comprising fifth and sixth construction units, said fifth and sixth construction units adapted to fit within said freestanding structure between said first and fourth construction units and across said second construction unit to further brace the freestanding structure.

12. The toy of claim 11, wherein the second construction unit includes at least two oblong recesses and each of said fifth and sixth construction units include at least one corresponding oblong recess each, two of the at least two oblong recesses of the second construction unit adapted to mate with the oblong recesses of the fifth and sixth construction units to connect the three units.

13. The toy of claim 10, wherein two sets of first, second, fourth, fifth, and sixth construction units, both assembled into separate freestanding structures, may be linked together by the third construction unit.

14. The toy of claim 13, wherein a third set of first, second, fourth, fifth, and sixth construction units may be linked together by a seventh construction unit.

15. The toy of claim 14, wherein the seventh construction unit is identical to the third construction unit.

16. The toy of claim 1, wherein the third construction unit is selected from the group consisting of nails, bolts, and pins.

17. The toy of claim 16, wherein the pin is planar.

18. The toy of claim 16, wherein the nail includes a head and a shaft extending therefrom, the shaft further including a series of ribs, each spanning less than the total circumference of the nail.

19. A wrench, the wrench comprising:
a working end having a shaped open area;
a handle attached to the working end;
a stop associated with the shaped open area, the stop adapted to prevent the working end from sliding past the head of a conventional bolt.

20. The wrench of claim 19, wherein the stop is located adjacent the shaped open area.

21. The wrench of claim 19, further comprising at least one additional stop, the at least one additional stop also adapted to prevent the working end from sliding past the head of a conventional bolt.

22. A kit of component parts for a child's construction toy, the kit comprising:
a first construction unit having a first matrix of at least three evenly spaced assembly members selected from the group consisting of notches, tabs, square apertures, circular apertures, oblong recesses, and tapered oblong recesses,
a second construction unit having a second matrix of at least three evenly spaced assembly members selected from the group consisting of notches, tabs, square apertures, circular apertures, oblong recesses, and tapered oblong recesses;
a third construction unit adapted to connect the first construction unit to the second construction unit, wherein the first construction unit and the second construction unit do not touch.

23. The toy of claim 22, wherein the third construction unit includes a first matrix of at least three evenly spaced assembly members corresponding to the at least three evenly spaced assembly members of the first construction unit and a second matrix of at least three evenly spaced assembly members corresponding to the at least three evenly spaced assembly members of the second construction unit.
